(19) United States
(12) Patent Application Publication
(10) Pub. No.: US 2006/0076722 A1
(43) Pub. Date: Apr. 13, 2006

(54) Motor vibration damping device

(76) Inventors: Hsu-Hsin Huang, Yuanlin Township (TW); I-Ping Chiu, Banciao City (TW); Chun-Ming Shen, Banciao City (TW)

Correspondence Address: RABIN & Berdo, PC, 1101 14TH STREET, NW, SUITE 500, WASHINGTON, DC, 20005, US

(21) Appl. No.: 11/221,753

(22) Filed: Sep. 9, 2005

(30) Foreign Application Priority Data
Sep. 29, 2004 (TW) 93129492

(51) Int. Cl. F16F 13/00

(52) U.S. Cl. 267/293; 267/140.12

(57) ABSTRACT

A motor vibration damping device includes several dampers and a connecting part. Each damper is disposed in a fixing hole of a mechanic fixing piece for reducing motor vibration energy transmitted to the mechanic fixing piece and the connecting part connects the dampers.

This application claims the benefit of Taiwan application Serial No. 93129492, filed Sep. 29, 2004, the subject matter of which is incorporated herein by reference.

### BACKGROUND OF THE INVENTION

1. Field of the Invention

The invention relates in general to a motor vibration damping device, and more particularly to a motor vibration damping device, which can reduce high-frequency noise generated by the motor.

2. Description of the Related Art

FIG. 1A is a lateral view of the conventional motor disposed on the mechanic fixing piece. Referring to FIG. 1A, the motor 100 includes a holding piece 102, which can be screwed on the mechanic fixing piece 120 by the screws 110. For the holding piece 102 and the mechanic fixing piece 120 are both metal pieces, if there is no medium disposed between the two metal pieces as buffer, motor vibration energy will be easily transmitted to the mechanic fixing piece 120 via the holding piece 102 to generate resonance noise. Especially when two different kinds of metals are fixed together, the frequency resonance effect will be enhanced, and thereby it generates high-frequency noise.

FIG. 1B and FIG. 1C are a back view and a lateral view of the conventional motor holding piece fixed on the mechanic fixing piece by the dampers, respectively. Refer to FIG. 1B and FIG. 1C at the same time. In the prior art, three dampers 130 are disposed between the holding piece 102 of the motor 100 and the mechanic fixing piece 120. The three dampers 130, configured by equal distance from one another in two-dimension plane, are used for reducing motor vibration energy transmitted to the mechanic fixing piece 120. Each damper 130, having a H-shape, includes a first vibration damping part 132 and a second vibration damping part 134 at each end, respectively. The first vibration damping part 132 is padded between the holding piece 102 and the mechanic fixing piece 120, and the second vibration damping part 134 is padded between the mechanic fixing piece 120 and the screws 110. Each of the first vibration damping part 132 and the second vibration damping part 134 has six vibration damping ribs 136 configured symmetrically in a radiate direction for reducing motor vibration energy transmitted to the mechanic fixing piece 120 via the holding piece 102 and the screws 110.

However, fabricating these dampers 130 onto the mechanic fixing piece 120 usually takes a long time. Especially when the size of the motor is small, such as the color wheel motor in a projector, the small-scale dampers are required, and thereby the fabrication time is increased. Moreover, the accuracy of positioning the damper 130 between the holding piece 102 and the mechanic fixing piece 120 will be reduced after the damper 130 is strongly fastened by the screw 110. Therefore, the resonance high-frequency noise and the start high-frequency noise generated between the holding piece 102 and the mechanic fixing piece 120 cannot be effectively prevented.

### SUMMARY OF THE INVENTION

It is therefore an object of the invention to provide a motor vibration damping device. By using a connecting part to combine a number of dampers into a single piece, not only motor vibration energy transmitted to the mechanic fixing piece can be reduced to prevent high-frequency noise generated by the motor, but also the fabrication time and the manufacturing cost can be lowered.

The invention achieves the above-identified object by providing a motor vibration damping device. The motor has a holding piece for fixing the motor on the mechanic fixing part, and the mechanic fixing part has a number of fixing holes. The motor vibration damping device includes a number of dampers and a connecting part. Each damper is disposed in the corresponding fixing hole for reducing motor vibration energy transmitted to the mechanic fixing piece, and the connecting part is for connecting the dampers. By using the connecting part to combine the dampers into a single piece, not only high-frequency noise generated by the motor vibration but also the fabrication time and manufacturing cost can be reduced.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A (Prior Art) is a lateral view of the conventional motor disposed on the mechanic fixing piece.

FIG. 1B (Prior Art) is a back view of the conventional motor holding piece fixed on the mechanic fixing piece by dampers.

FIG. 1C (Prior Art) is a lateral view of the conventional motor holding piece fixed on the mechanic fixing piece by dampers.

FIG. 2A is a lateral view of the motor fixed on the mechanic fixing piece configured with a motor vibration damping device according to the first embodiment of the invention.

FIG. 2B is a vertical view of the motor vibration damping device in FIG. 2A.

FIG. 2C is a lateral view of the motor vibration damping device in FIG. 2A.

FIG. 2D is a partial cross-sectional diagram of the holding piece and the mechanic fixing piece fastened by the screws and the dampers in FIG. 2A.

FIG. 3A is a lateral view of motor fixing structure using the motor vibration damping device according to the second embodiment of the invention.

FIG. 3B is a vertical view of the explored motor vibration damping device in FIG. 3A.

FIG. 3C is a lateral view of the explored motor vibration damping device in FIG. 3A.

FIG. 3D is a partial lateral view of the holding piece and the mechanic fixing piece fastened by a screw and a damper in FIG. 3A.

FIG. 4 is diagram of relationship between the damper thickness and the length of the screw shoulder part in FIG. 2A and FIG. 3A.

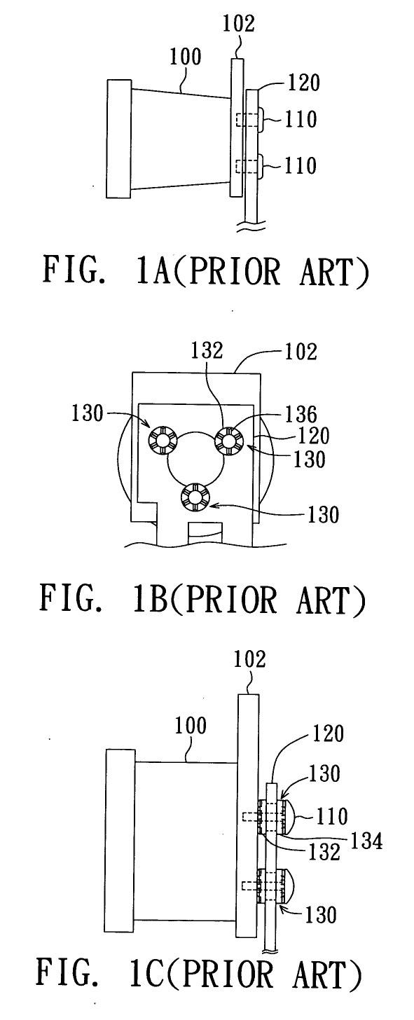

### DETAILED DESCRIPTION OF THE INVENTION

In the following description, two embodiments are taken for example to illustrate the structure of the motor vibration damping device and how to achieve the purpose of reducing motor vibration energy transmission in the invention.

### Embodiment One

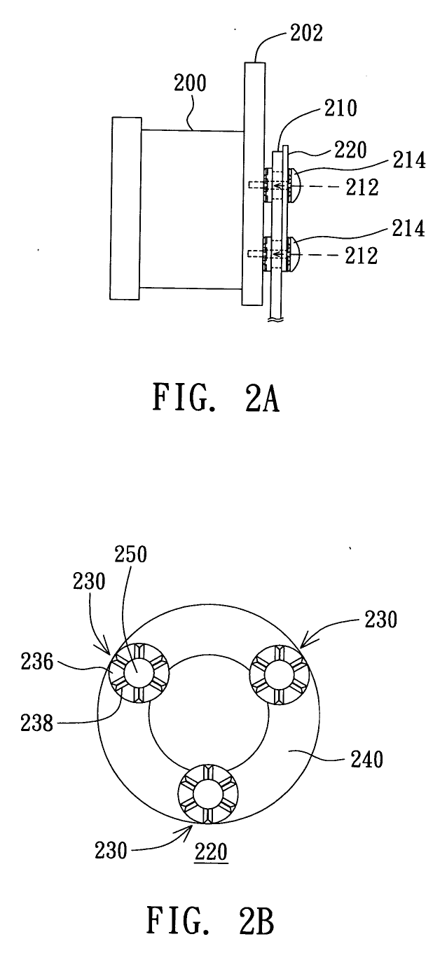

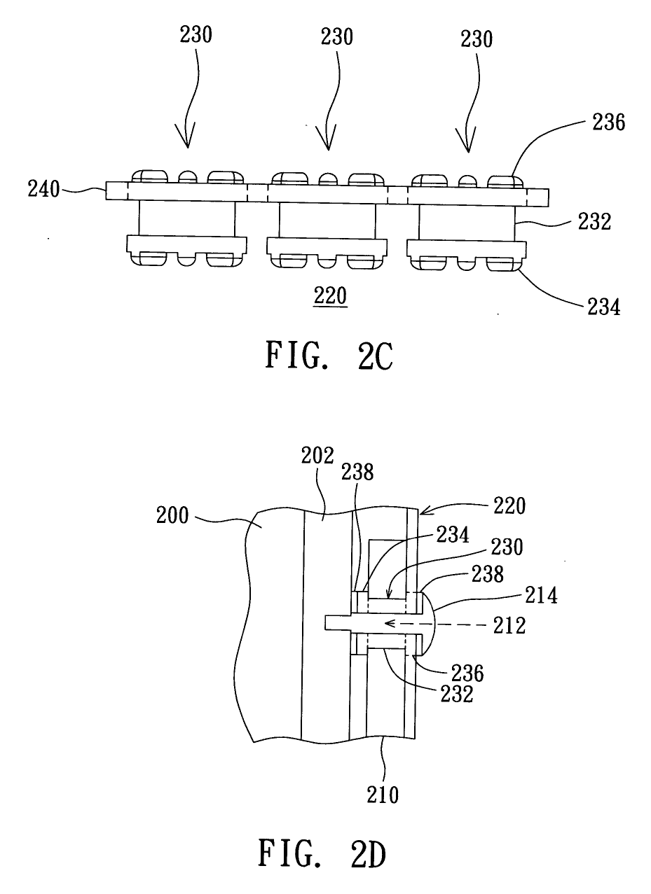

Referring to FIG. 2A, a lateral view of fixing the motor on the mechanic fixing piece configured with a motor vibration damping device according to the first embodiment of the invention is shown. The motor 200, such as the color wheel motor in a projector, usually has a holding piece 202 for fixing the motor 200 on the mechanic fixing piece 210. The mechanic fixing piece 210 has three fixing holes 212, configured by an equal distance from one another in two-dimension plane, for combining with the screws 214 to fix the holding piece 202 on the mechanic fixing piece 210. Only two fixing holes 212 are shown in FIG. 2A to avoid figure complication. The motor vibration damping device 220 is disposed on the mechanic fixing piece 210 for reducing motor vibration energy transmitted through the holding piece 202 directly or further through the screws 214 to the mechanic fixing piece 210.

Referring to FIG. 2B and FIG. 2C at the same time, a vertical view and a lateral view of the motor vibration damping device 220 in FIG. 2A are shown, respectively. The motor vibration damping device 220 includes three dampers 230 and a connecting part 240. The connecting part 240 is used for connecting the three dampers 230, and the dampers 230 are configured equally distant from one another in two-dimension plane. The connecting part 240 and the dampers 230 can be manufactured into a unity. Each damper 230, having a H-shape, includes a body part 232, a first vibration damping part 234 and a second vibration damping part 236. The first vibration damping part 234 and the second vibration damping part 236 are connected to two ends of the body part 232, respectively. The connecting part 240, which can be a circular connecting plate, is for connecting the three second vibration damping parts 236. As shown in FIG. 2B and FIG. 2C, each of the first vibration damping part 234 and the second vibration damping part 236 includes six vibration damping ribs 238, configured symmetrically in a radiate direction from the central screw hole 250.

Referring to FIG. 2D, a partial cross-sectional diagram of the holding piece 202 and the mechanic fixing piece 210 fastened by screws 214 and the dampers 230 in FIG. 2A is shown. The damper 230 is disposed at the corresponding fixing hole 212 for preventing motor vibration energy from being transmitted to the mechanic fixing piece 210 via the holding piece 202 or the screw 214 to generate high-frequency noise. In terms of detailed structure, the body part 232 in the middle of the damper 230 is disposed in the fixing hole 212, and the first vibration damping part 234 at one end of the damper 230 is padded between the holding piece 202 and the mechanic fixing piece 210 so as to reduce motor vibration energy transmitted to the mechanic fixing piece 210 directly through the holding piece 202. The second vibration damping part 236, located at the other end of the damper 230 and connected with the connecting part 240, is padded between the mechanic fixing piece 210 and the screw 214 so as to reduce motor vibration energy transmitted to the mechanic fixing piece 210 further through the screw 214.

Therefore, when vibration energy generated by the rotation of the motor 200 is transmitted to the motor vibration damping device 220 via the holding piece 202, by deformation of the ribs 238 on the first vibration damping part 234, vibration energy transmitted to the mechanic fixing piece 210 can be reduced. Thereby it reduces high-frequency noise generated by motor rotation. Similarly, by deformation of the ribs 238 on the second vibration damping part 236, vibration energy transmitted to the mechanic fixing piece 210 further by the screws 214 can be reduced. As a result, the high frequency noise due to the rotation of the motor 200 can be reduced. In the embodiment, the fabrication direction of the motor vibration damping device 220 relative to the holding piece 202 and the mechanic fixing piece 210 is not limited to the above-mentioned direction. The reverse direction can also be used to achieve the same vibration damping effect, i.e. the second vibration damping part 236 connected to the connecting part 240 is padded between the holding piece 202 and the mechanic fixing piece 210, and the first vibration damping part 234 is padded between the mechanic fixing piece 210 and the screw 214. In addition, using the connecting part 240 to combine three dampers 230 into a single piece can save the fabrication time of disposing the dampers 230 piece by piece in the fixing hole 212 in the prior art. For only one mold is required to manufacture the vibration damping device 220, i.e. three dampers 230 as well as a connecting part 240 can be formed at a time, the manufacturing cost of the invention is lower than that in prior art which uses a mold to form just a damper.

### Embodiment Two

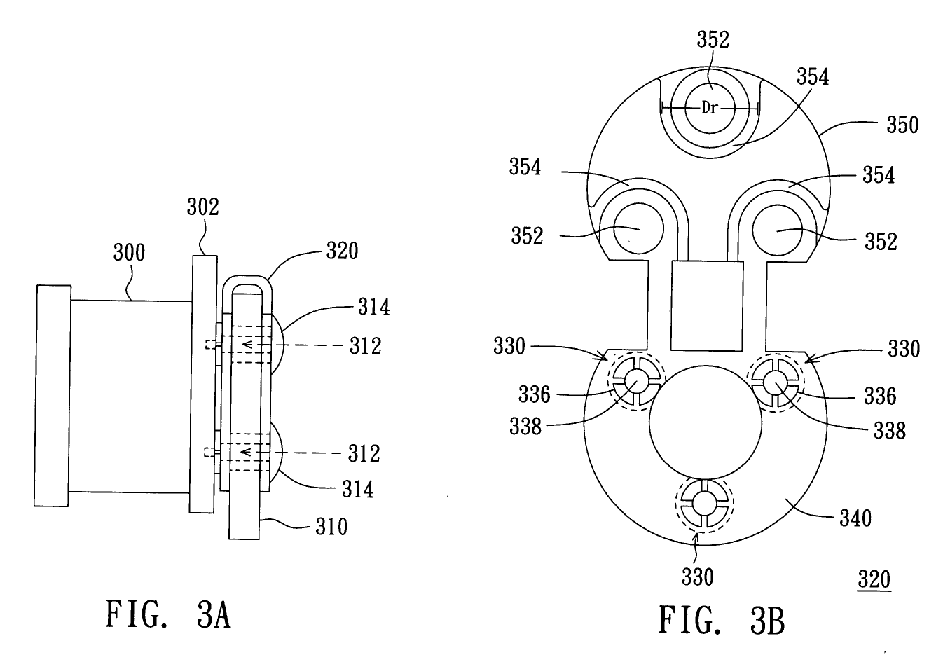

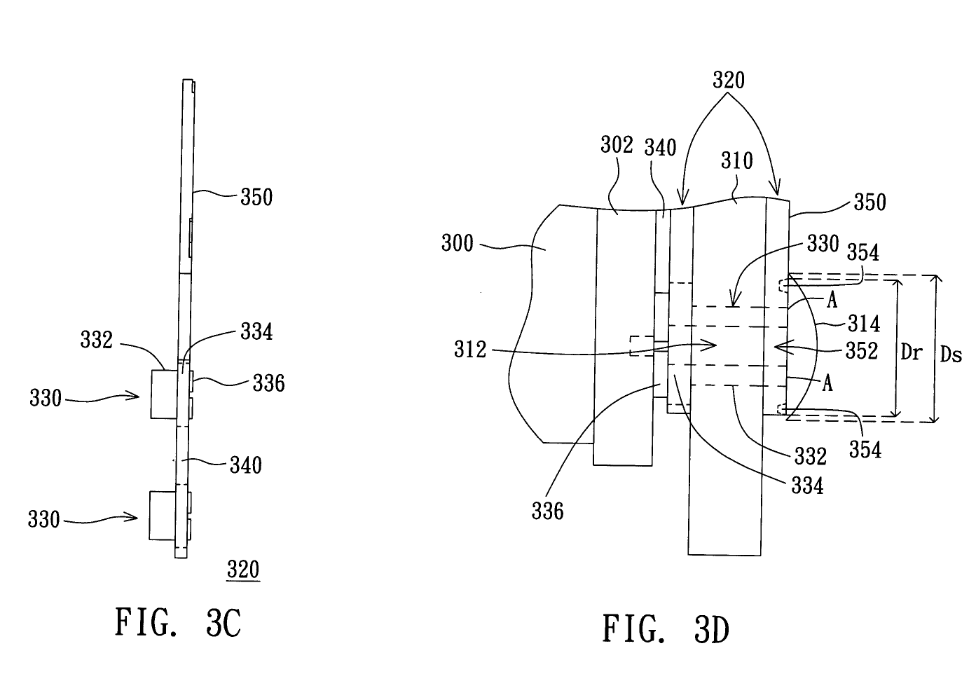

Referring to FIG. 3A, a lateral view of motor fixing structure using the motor vibration damping device according to the second embodiment of the invention is shown. The motor 300, such as the color wheel motor in a projector, includes a holding piece 302 for fixing the motor on the mechanic fixing piece 310. The mechanic fixing piece 310 has three fixing holes 312 configured equally distant from one another in two-dimension plane. Three fixing holes 312 together with three screws 314 are used to fix the holding piece 302 on the mechanic fixing piece 310. The lateral figure FIG. 3A shows only two screw holes 312 in order to prevent complication. The vibration damping device 320 is for reducing vibration energy transmitted to the mechanic fixing piece 310 via the holding piece 302 and the screws 314.

Referring to FIG. 3B and FIG. 3C, a vertical view and a lateral view of the explored motor vibration damping device 320 in FIG. 3A are shown. The motor vibration damping device 320 includes three dampers 330, a connecting part 340, and a vibration damping pad 350. The connection part 340, which can be a circular connecting plate, is for connecting the three dampers configured equally distant from one another in two-dimension plane and the vibration damping pad 350 is connected to the connecting part 340. The dampers 330, the connecting part 340, and the vibration damping pad 350 can be manufactured into a unity. The vibration damping pad 350 includes three linking holes 352, configured in correspondence with the fixing holes 312, and a circular groove 354 is formed around each linking hole 352 for reducing motor vibration energy transmitted to the mechanic fixing piece 310 via the screw 314. Each damper 330 includes a body part 332 and a vibration damping part 334. One end of the body part 332 is connected to the vibration damping part 334 and the vibration damping part 334 is connected to the connecting part 340. The vibration damping part 334 includes four vibration damping ribs 336 which are configured radially outward from the edge of the central screw hole 338 and keep equal distance from adjacent ribs 336.

Referring to FIG. 3D, a partial lateral view of the holding piece 302 and the mechanic fixing piece 310 fastened by a screw 314 and a damper 330 in FIG. 3A is shown. The vibration damping pad 350 is padded between the mechanic fixing piece 310 and the screw 314. The body part 332 of the vibration damping piece 330 is disposed in the fixing hole 312 and through the corresponding linking hole 352 of the vibration damping pad 350. That is, the top end A of the body part 332 can just touch the head of the screw 314 as shown in the figure. The vibration damping part 334 and the connecting part 340 are padded between the holding piece 302 and the mechanic fixing piece 310. By the deformation of the vibration damping ribs 336 on the vibration damping part 334, vibration energy transmitted to the mechanic fixing piece 310 directly through the holding piece 302 can be reduced. Moreover, the diameter of circular groove 354 of the vibration damping pad 350 is smaller than that of the head of the corresponding screw 314 so as to effectively prevent motor vibration from being transmitted to the mechanic fixing piece 310 further through the screw 314.

Therefore, when vibration energy generated by the rotation of the motor 300 is transmitted to the motor vibration damping device 320 via the holding piece 302, by the deformation of the ribs 336 on the first vibration damping part 334, vibration energy transmitted directly to the mechanic fixing piece 310 can be reduced Similarly, by the deformation of the circular groove 354 of the vibration damping pad 350, vibration energy transmitted to the mechanic fixing piece 310 further by the screws 314 can be reduced. Thereby high-frequency noise generated by motor rotation can be reduced. In addition, using the connecting part 340 to combine three dampers 330 into a single piece can save the fabrication time of disposing the dampers 330 piece by piece on the fixing hole 312 in the prior art. For only one mold is required to manufacture the vibration damping device 320 and three dampers 330 can be formed at a time, the manufacturing cost of the invention is lower than that of the prior art which uses a mold to form just a damper.

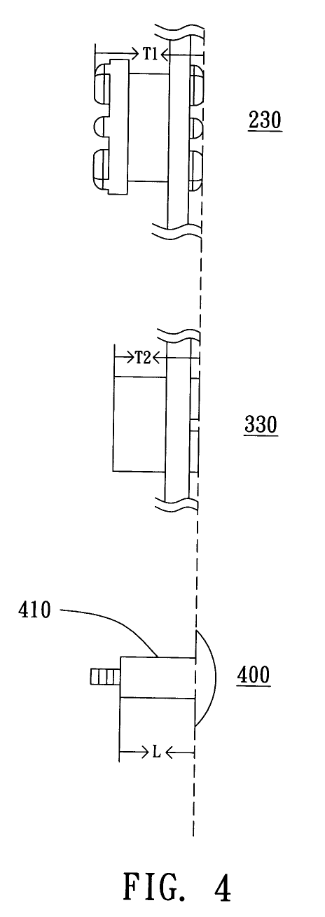

Furthermore, as shown in FIG. 4, in order to effectively reduce motor vibration energy transmitted to the mechanic fixing piece 210 or 310 by using the dampers 230 or 330, the screws 214 or 314 can be shoulder-shape screws 400. The shoulder-shape screw 400 has a shoulder part 410 for preventing the issue that the damper 230 or 330 is compressed to result in non-proper positioning and frequency resonance of the motor not being able to be effectively reduced because the screw 400 is too strongly screwed into the hole 212 or 312. The thickness T1 or T2 of each damper 230 or 330 should be so larger than the length of the shoulder part 410 of the corresponding shoulder-shape screw 400 that the ribs 238 of the damper 230 or the ribs 336 of the damper 330 has suitable deformation to effectively reduce motor vibration energy transmitted to the mechanic fixing piece 210 or 310 as the shoulder-shape screw 400 is screwed into the screw hole 212 or 312.

As mentioned above, although three dampers, each of which has four or six vibration damping ribs configured symmetrically in a radiate direction, are taken as an example, the motor vibration damping device of the invention can have other number of dampers, such as four dampers configured at four corners of the connect part. The damper can also have other number and other configuration of vibration damping ribs, and the vibration damping rib can even be in other shape, such as a groove shape. As long as the vibration damping device has the dampers disposed in the fixing holes and padded between the holding piece and the mechanic fixing piece and between the mechanic fixing piece and the screw, respectively, to achieve the purpose of reducing motor vibration energy transmitted to the mechanic fixing piece, and has the connecting part to connect all the dampers together so as to save fabrication time, it will not be apart from the skill scope of the invention. Moreover, although the circular or circle-like connecting plate is taken as an example of the connecting part in the embodiment, the connecting part of the invention is not limited thereto. In the application, the connecting part for connecting each damper can be adjusted according to the actual mechanism design.

The motor vibration damping device disclosed by the two above-mentioned embodiments in the invention has the following advantages. A number of dampers combined to a single piece can not only reduce motor vibration energy transmitted to the mechanic fixing piece and the high-frequency noise generated thereby, but also effectively reduce the fabrication time. Moreover, because a number of dampers can be manufactured into a unity by a mold at a time, the manufacturing cost is reduced accordingly.

While the invention has been described by way of two preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A motor vibration damping device for being used with a motor, the motor comprising a holding piece for fixing the motor on a mechanic fixing piece, the mechanic fixing piece comprising a plurality of fixing holes, the motor vibration damping device comprising:
a plurality of dampers, disposed in the fixing holes, respectively; and
a connecting part, for connecting the dampers.

2. The motor vibration damping device according to claim 1, wherein each of the dampers comprises a body part, a first vibration damping part, and a second vibration damping part, the first vibration damping part and the second vibration damping part are connected to the body part, and the second vibration damping part is connected to the connecting part.

3. The motor vibration damping device according to claim 2, wherein the body part is disposed in the fixing hole, and the first vibration damping part and the second vibration damping part are padded between the holding piece and the mechanic fixing piece and between the mechanic fixing piece and a screw screwed in the fixing hole, respectively.

4. The motor vibration damping device according to claim 2, wherein the body part is disposed in the fixing part, and the second vibration damping part and the first vibration damping part are padded between the holding piece and the mechanic fixing piece and between the mechanic fixing piece and a screw screwed in the fixing hole, respectively.

5. The motor vibration damping device according to claim 2, wherein each of the first vibration damping parts and the second vibration damping parts comprises a screw hole and a plurality of vibration damping ribs, and the vibration damping ribs are configured symmetrically in a radiate direction from the screw hole.

6. The motor vibration damping device according to claim 1, wherein the motor vibration damping device further comprises a vibration damping pad connected to the connection part, each of the dampers comprises a body part and a vibration damping part, one end of the body part is connected to the vibration damping part, and the vibration damping part is connected to the connecting part.

7. The motor vibration damping device according to claim 6, wherein the vibration damping pad is padded between the mechanic fixing piece and a plurality of screws screwed into the fixing holes, each of the body parts is disposed in the corresponding fixing hole, and the dampers and the connecting part are padded between the holding part and the mechanic fixing part.

8. The motor vibration damping device according to claim 7, wherein the vibration damping pad comprises a plurality of linking holes corresponding to the fixing holes, and a circular groove is formed around each linking hole.

9. The motor vibration damping device according to claim 8, wherein the diameter of each circular groove is smaller than the diameter of a head of the corresponding screw.

10. The motor vibration damping device according to claim 8, wherein each body part is combined with a linking hole of the vibration damping pad via the corresponding fixing hole.

11. The motor vibration damping device according to claim 8, wherein each vibration damping part comprises a screw hole and a plurality of vibration damping ribs, and the vibration damping ribs are configured radially outward from the edge of the screw hole at a constant interval.

12. The motor vibration damping device according to claim 6, wherein the vibration damping pad, the dampers, and the connecting part are manufactured into a unity.

13. The motor vibration damping device according to claim 1, wherein the holding piece is fixed on the mechanic fixing part via a plurality of shoulder-shape screws, and the thickness of each damper is larger than the length of a shoulder part of the corresponding shoulder-shape screw.

14. The motor vibration damping device according to claim 1, wherein the dampers and the connecting part are manufactured into a unity.
